(19) United States
(12) Patent Application Publication
(10) Pub. No.: US 2008/0147875 A1
(43) Pub. Date: Jun. 19, 2008

(54) SYSTEM, METHOD AND PROGRAM FOR MINIMIZING AMOUNT OF DATA TRANSFER ACROSS A NETWORK

(75) Inventor: Jason Matthew Stapels, Endicott, NY (US)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/611,994

(22) Filed: Dec. 18, 2006

(51) Int. Cl. G06F 15/16

(52) U.S. Cl. 709/232

(57) ABSTRACT

A computer system, method and program for reducing data transfer associated with a request for a web page. In response to a first request from a client computer for a first web page, a server downloads the first web page to the client computer, and the client computer stores the first web page. In response to a second, subsequent request from the client computer for a second web page, the server downloads to the client computer differences between the second web page and the first web page. The client computer constructs the second web page based on the first web page and the differences between the second web page and the first web page.

### FIELD OF THE INVENTION

The invention relates generally to computer systems and networks, and more specifically to minimizing an amount of data that needs to be transferred across a network.

### BACKGROUND OF THE INVENTION

Computer systems and networks, such as client computers, servers and the Internet, are well known today. Known web browser programs (such as provided by AOL™, Compuserve™ and Road Runner™ web browser programs) are installed on the client computers to interact with web servers via the Internet. For example, a user via a web browser can request a web page from a web server via the Internet. A web page can be a user interface to a web applications at the web server and/or provide data to the user of the client computer. Typically, the web page is downloaded to the client computer in HTML form. Web files can also be downloaded to clients, for example, using XML or JSON form.

There are different types of communication media between the web server and the client computer. Typically, there is a high speed connection between the web server and Internet Service Providers (“ISPs”) or other routers, switches and/or gateway computer for the client computer. However, when the volume of web pages requested from a web server becomes excessive, even the high speed connections and associated network devices become overwhelmed, i.e. the “bandwidth” is insufficient. Moreover, some client computers have a relatively slow connection, such as a “dial-up” telephone line, to their ISP or gateway computer, and download of web pages or other data files containing much data is time consuming.

An object of the present invention is to minimize the amount of data that needs to be downloaded from a web server to a client computer.

### SUMMARY OF THE INVENTION

The present invention resides in a computer system, method and program for reducing data transfer associated with a request for a web page. In response to a first request from a client computer for a first web page, a server downloads the first web page to the client computer, and the client computer stores the first web page. In response to a second, subsequent request from the client computer for a second web page, the server downloads to the client computer differences between the second web page and the first web page. The client computer constructs the second web page based on the first web page and the differences between the second web page and the first web page.

According to a feature of the present invention, the differences comprise a container of an HTML of the second web page where at least one character in the container of the second web page differs from at least one corresponding character in a corresponding container of the first web page. The client computer constructs the second web page by substituting the container of the HTML for the second web page for the corresponding container of the HTML of the first web page.

According to another feature of the present invention, the server stores the first web page and compares an HTML for the second web page to an HTML for the first web page, container by container, to identify which containers of the HTML for the second web page differ from corresponding containers of the HTML for the first web page to determine differences between the second web page and the first web page.

### BRIEF DESCRIPTION OF THE FIGURES

FIG. 1 is a block diagram of a distributed computer system with a data management server and client computers according to the present invention.

FIG. 2 is a flow chart of a web page differencing program and front end hardware and/or software function at the data management server of FIG. 1.

FIG. 3 is a flow chart of a web page reconstitution program and other browser functions at the client computer of FIG. 1.

FIG. 4 is a flow chart illustrating in more detail the web page reconstitution program of FIG. 2.

FIG. 5 is a flow chart illustrating in more detail the web page reconstitution program of FIG. 2.

FIG. 6 is a flow chart illustrating in more detail the web page differencing program of FIG. 2.

FIG. 7 is a flow chart illustrating a web page conversion routine of FIG. 1.

FIG. 8 is a flow chart illustrating a compare program routine of FIG. 1.

FIG. 9 is a flow chart illustrating a web page reconstitution program of FIG. 3.

### DETAILED DESCRIPTION OF THE PREFERRED EMBODIMENTS

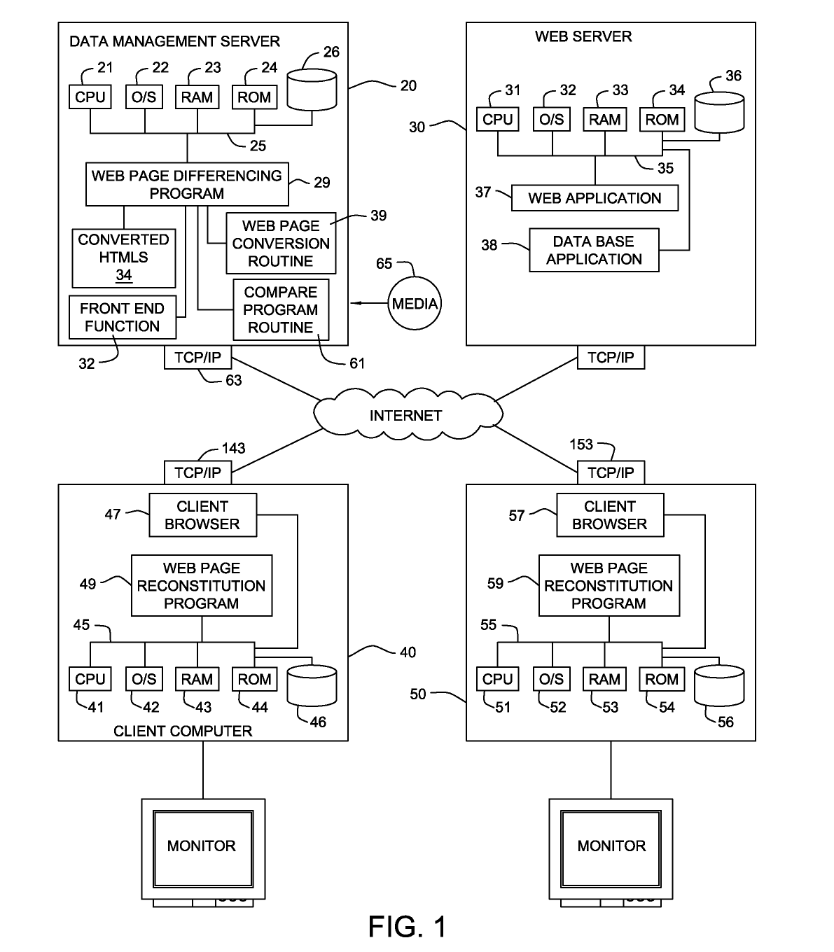

The present invention will now be described in detail with reference to the figures. FIG. 1 illustrates a distributed computer system generally designated 10 in which the present invention is incorporated. System 10 comprises a data management server 20 with a known CPU 21, operating system 22, RAM 23 and ROM 24 on a common bus 25 and storage 26. In the illustrated embodiment, data management server 20 is an intermediary between client computers 40 and 50 and web server(s) 30 which provide the actual web service and web pages requested by users of the client computers.

Each of the web server(s) 30 includes any of a variety of known web applications 37 such as an e-commerce application. Each of the web servers 30 can also includes a known database application 38, such as IBM DB/2 database manager or Oracle database manager, to furnish web pages, web files and other data needed by the e-commerce application to provide a service to users of client computers 40 and 50. In another embodiment of the present invention, web application 37 and database application 38 can reside in server 20 to provide the web service, web pages and web files to the client computers 40 and 50.

Data management server 20 also includes a web page differencing program 29, web page conversion program routine 39, and compare program routine 61 according to the present invention. Program 29 tracks which web pages (which originate from web server(s) 30) were previously furnished to each client computer via data management server 20 and network 31 (such as the Internet). Program 29 compares each current request from a client computer for a web page to the web page (or optionally, web pages) previously furnished to the same client computer. Then, program 29 furnishes to the client computer the differences between the currently requested web page and the previously furnished (and typically, currently displayed) web page. The client computer has cached the previously downloaded web page (or optionally, web pages), so that the client computer can construct the currently requested web page from the differences and the previously furnished web page. Often, the difference file downloaded from the server 20 to the client computer is substantially smaller than the currently requested web page in its entirety. Consequently, there is less information to download and therefore less burden on the networks and less bandwidth utilized.

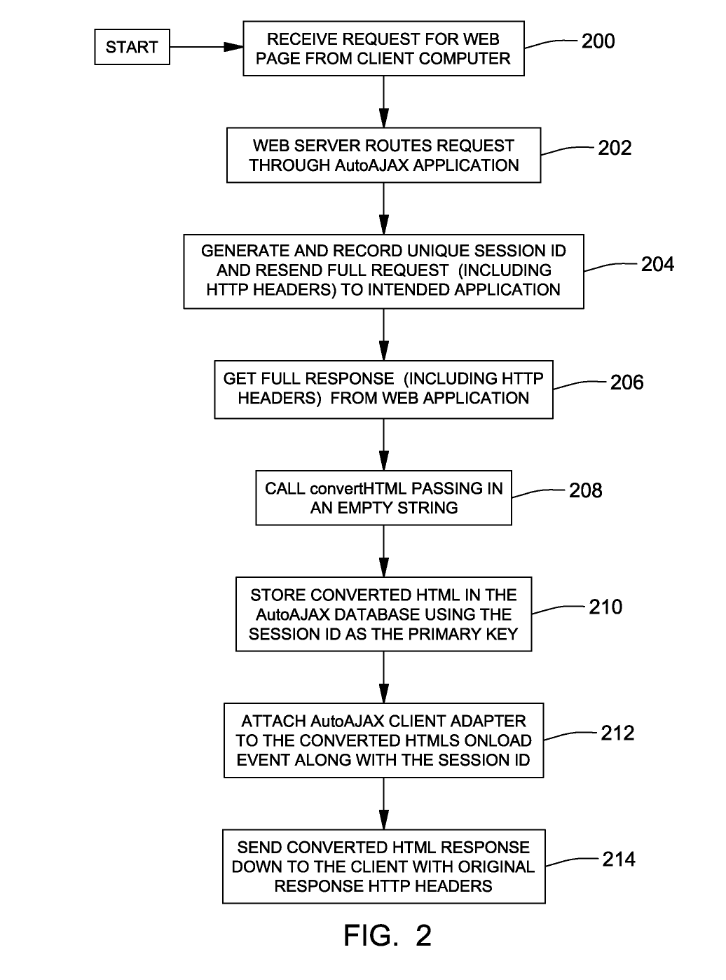

Client computer 40 includes a web page reconstitution program 49, and client computer 50 also includes an identical web page reconstitution program 59. Each web page reconstitution program modifies the previously downloaded and cached web page according to the differences which are received from the web server 20, to generate a currently requested web page. The function and operation of programs 29, 49 and 59 are described in more detail below with reference to the flow charts of FIGS. 2-9.

Client computer 40 also includes a known CPU 41, operating system 42, RAM 43 and ROM 44 on a common bus 45 and storage 46 and web browser 47. Client computer 50 also includes a known CPU 51, operating system 52, RAM 53 and ROM 54 on a common bus 55 and storage 56 and web browser 57.

FIG. 2 illustrates in more detail the operation and function of the web page differencing program 29 and front end hardware and/or software function 32 at data management server 20 when processing an initial request from a client computer that elicits a responsive web page from web server 30 via server 20. (RUN ON) In step 200, front end function 32 receives an initial request from one of the client computers such as client computer 40 for web application 27. This request was initiated from a user at client computer 40 or an application within client computer 40, and will elicit a web page in response. This is the first web page requested from the client computer 40 to application 27 within the current session. As explained in more detail below, the user at client computer 40 or application within client computer 40 made the request directly to server 30, but the web page reconstitution program 49 within the client computer redirected the request to server 20. In response to the request from client computer 40, front end function 32 forwards the request to web page differencing program 29 within server 20 (step 202). In response, program 29 generates a unique session ID for the request, and forwards the client request (including HTTP headers) with the unique session ID to web application 27 in web server 30 (step 204). Program 29 also records the unique session ID along with a timestamp (so inactive sessions may be cleaned) in a file 33 to associate the request with the requesting client computer. The web application 27 processes the request, fetches a web page and returns the web page to program 29 in server 20 (step 206). In this example, the web page is in HTML form and includes HTTP headers. Next, program 29 calls a web page conversion program routine 39 in server 20, passing an empty string (step 208). The empty string indicates that the conversion routine process the HTML in its entirety. In response, the conversion routine 39 identifies different container tags of the requested web page, and indexes each container tag based on a numbering scheme. In HTML, a “container tag” is a pair of symbols surrounding data where the symbols indicate the nature of the data and/or how it is to be displayed. The following is an example of an indexing scheme which uniquely identifies each container in the HTML. The “parent” or primary container tags are numbered sequentially. However, if a parent container tag contains one or more other “children” container tags, the children container tags are numbered with suffixes from the parent container tag. For example if a parent container tag has index number “5”, then its two children may have indexes “5-1” and “5-2”. The conversion routine 39 then returns to program 29 the indexed containers of each HTML as a “converted” HTML. In response, program 29 stores the converted HTML (i.e. the indexed container tags with their respective data portions of the HTML) in a database 34 using the session ID as the primary key to access the converted HTML (step 210). Next, program 29 adds to the converted HTML an “onload” call to the web page reconstitution program 49 at the requesting client computer, along with the session ID for the request. Because this is the initial web page requested by the client computer to the server 30 during this session, the server 20 caches and also returns to the client computer the converted HTML (step 214), not a difference file. (As explained in more detail below, for subsequent requests from the client during the same session, the server 20 will return the differences between the currently requested HTML and the previously downloaded HTML and the onload call, and the call will invoke the web page reconstitution program 49 at the client computer to generate the currently requested web page by applying the differences to the previously downloaded HTML (step 212).)

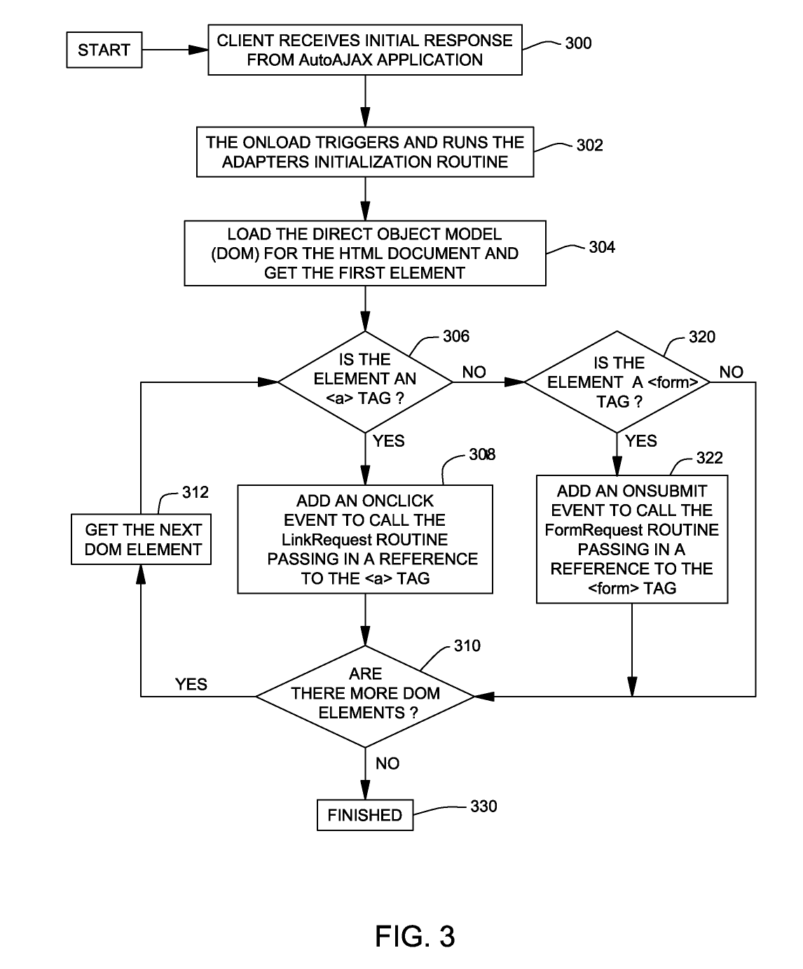

FIG. 3 illustrates in more detail the operation and function of web page reconstitution program 49 and other browser functions 48 at client computer 40 upon receipt of the converted HTML for the initial web page requested by the client computer. In step 300, the client computer 40 receives the converted HTML and original HTTP headers, onload call and session ID from server computer 20. The onload call invokes the web page reconstitution program 49 (step 302). In response, program 49 loads the converted HTML (as a Direct Object Module or “DOM”) and finds and gets the first HTML tag in the converted HTML (step 304). Next, program 49 determines if that tag is “<a>”, i.e. a tag indicating a hyperlink to another web page (decision 306). If so (decision 306, yes branch), then program 49 will modify the hyperlink with an “onclick” call such that if a user “clicks-on” the hyperlink, the web browser 47 based on the modified HTML will forward the request for the web page to web page reconstitution program 47 (step 308). Based on the onclick call, the web page reconstitution program 49 will send the request to server 20 instead of sending the request to the URL indicated in the original hyperlink container. Server 20 will act as an intermediary between the client computer and the server indicated by the URL of the original hyperlink, and send to the client computer the differences between the hyperlinked web page (received from the server indicated by the URL of the original hyperlink) and the previously downloaded web page.

After step 308, program 49 determines if there are any more tags in the converted HTML (decision 310). If so (decision 310, yes branch), then program 49 gets the next tag (step 312), and determines if the next tag is a hyperlink, i.e. a “<a>” tag (decision 306). If so (decision 306, yes branch), this is handled as before in step 208. If not (decision 306, no branch) or if the first tag was not a hyperlink tag, then program 49 determines if the tag is a “<form>” tag for the user to input data into a form (decision 320). If so (decision 320, yes branch) then program 49 modifies the form tag with an “onsubmit” call such that if a user enters data into the field, and then “clicks-on” a submit button at the client web browser display, the client web browser based on the HTML will forward the submit request to program 49 so that the form data can be collected and send the request to server 20 instead of to the URL indicated in the original form (step 322). If the tag was not a hyperlink tag or a form tag, then program 49 does not modify the HTML. Next, program 49 checks if there are any more tags in the modified HTML (decision 310), and processes any additional tags in the manner noted above, until all the tags have been processed (step 330).

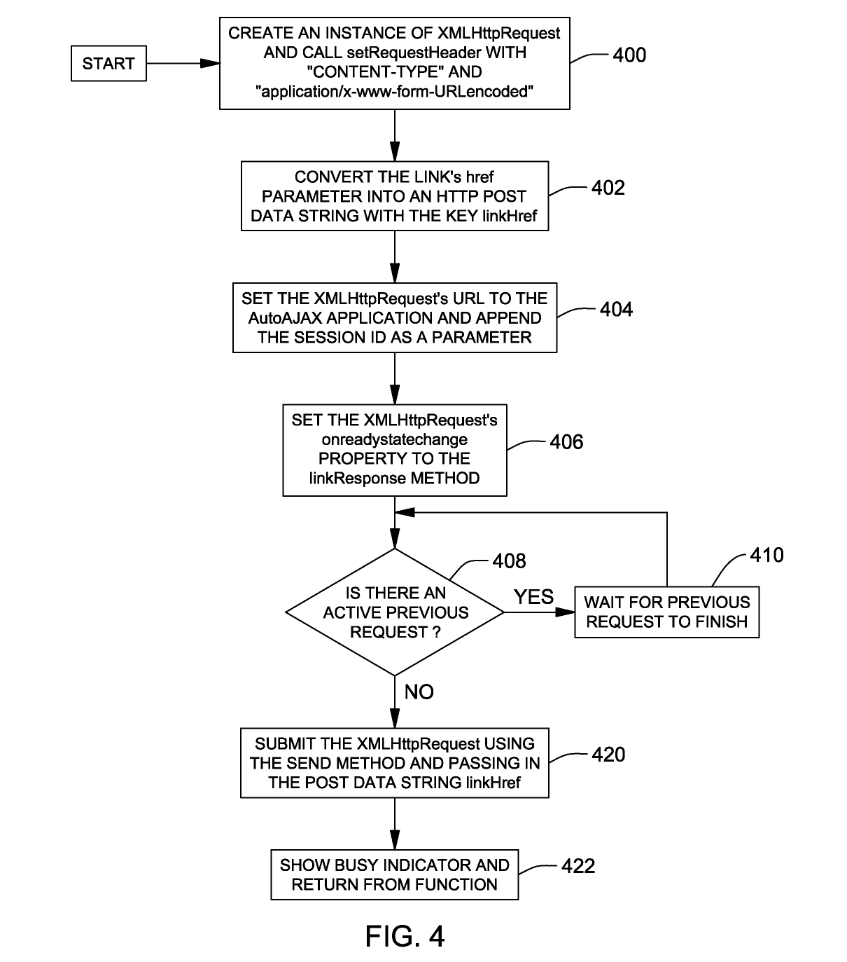

FIG. 4 illustrates in more detail the operation and function of program 49 when a user at client computer 40 clicks-on a hyperlink (represented by an <a> tag as noted above) displayed by web browser 47. In response to a user clicking-on the hyperlink (which was modified in step 308 with an onclick call), the web browser, based on the HTML, notifies program 49 as to the link which is requested (step 400). In response, program 49 converts the hyperlinked request to a form which first directs the request to web server 20, but also includes the URL of the web server (such as web server 30) that will provide the requested web page to the client computer via data management server 20 (steps 402 and 404). Next, program 49 sets the response identification for the request to the client computer 40 so that when server 20 asynchronously receives the response from the web server 30 (or other web server that provides the web page), web server 20 will know to forward the response to the client computer 40 (step 406). Next, program 49 waits for the response to the previous request before sending the current request for the hyperlink (decision 408 and step 410). After receiving the response to the previous request (decision 408, yes branch), program 49 sends the next request for the hyperlink to the web server that will provide the hyperlinked web page (step 420). Also, program 49 notifies the client computer 40 that the request is pending, and the client computer 40 will display a busy indicator to the user at the display of the client computer 40 (step 422).

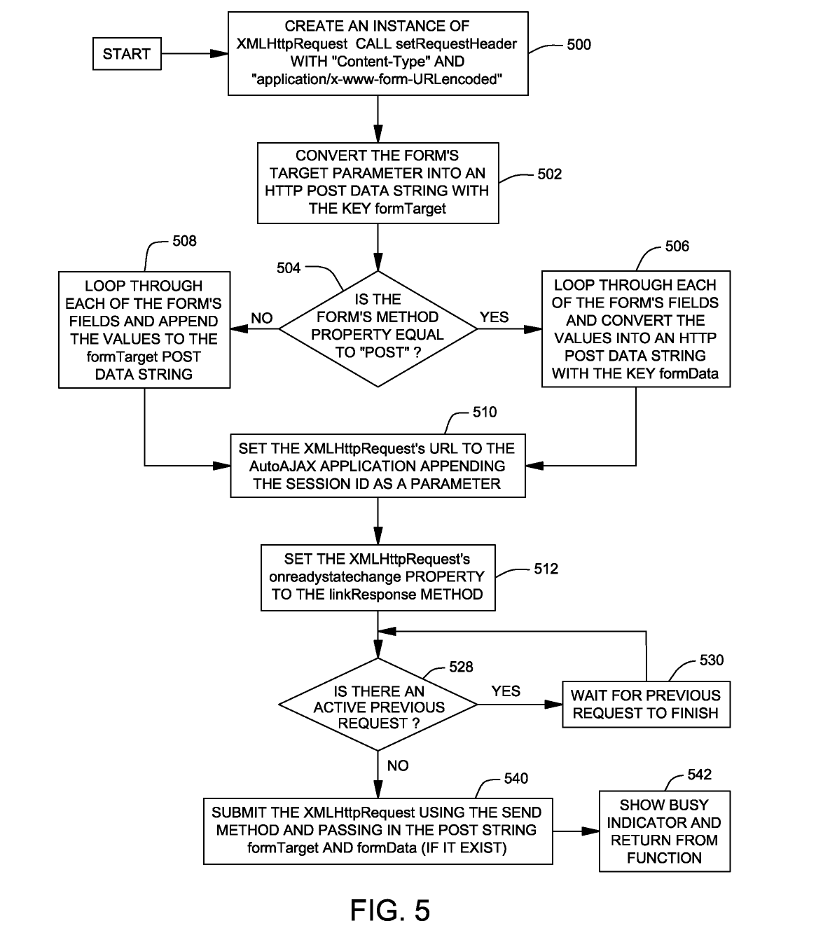

FIG. 5 illustrates in more detail the operation and function of program 49 when a user clicks-on a submit button (represented by a <form> tag as noted above) after entering data into the form field. In response to a user clicking-on a submit button or otherwise submitting a completed form (which was modified in step 322 with an onsubmit call), the web browser 47, based on the HTML, notifies program 49 as to the form for which data has been entered and submitted and program 49 creates the submit request for server 20 (step 500). Next, program 49 modifies the submit request so that it will go first to server 20 instead of the web server (such as web server 30) that will process the form (step 502). Next, program 49 determines from the HTML if the mode of transfer of the form is “post” mode (and if not, determines that it is “get” mode). The mode was set by the creator of the original HTML which defines the form. If it is post mode (decision 504, yes branch), then program 49 converts the values of the data entered into the form's fields into the post mode (step 506). Otherwise (decision 504, no branch), program 49 converts the values of the data entered into the form's fields into the get mode (step 508). After either step 506 or step 508, program 49 sets the form data of the submit request to the URL of server 20 instead of the URL of the web server that will process the form, and also appends the session ID (step 510). The submit request still includes the URL of the web server (such as web server 30) that will process the form, even though the submit request goes first to intermediary data management server 20. Next, program 49 appends to the submit request a “onready” call for a specific process such as “linkResponse” in the client computer when the response is received and processed at the client computer 40 (step 612). As explained in more detail below, the linkResponse process at the client computer 40 will process the JSON data returned from web server 20 and use that to update the displayed web page. Next, program 49 waits for the response to the previous request before sending the next/submit request to web server 20 (decision 528 and step 530). After receiving the response to the previous request (decision 528, no branch), program 49 sends the next/submit request to server 20 (step 540). Also, program 49 notifies the web browser 47 that the next/form request is pending, and the web browser will display a busy indicator to the user at client computer 40 (step 542).

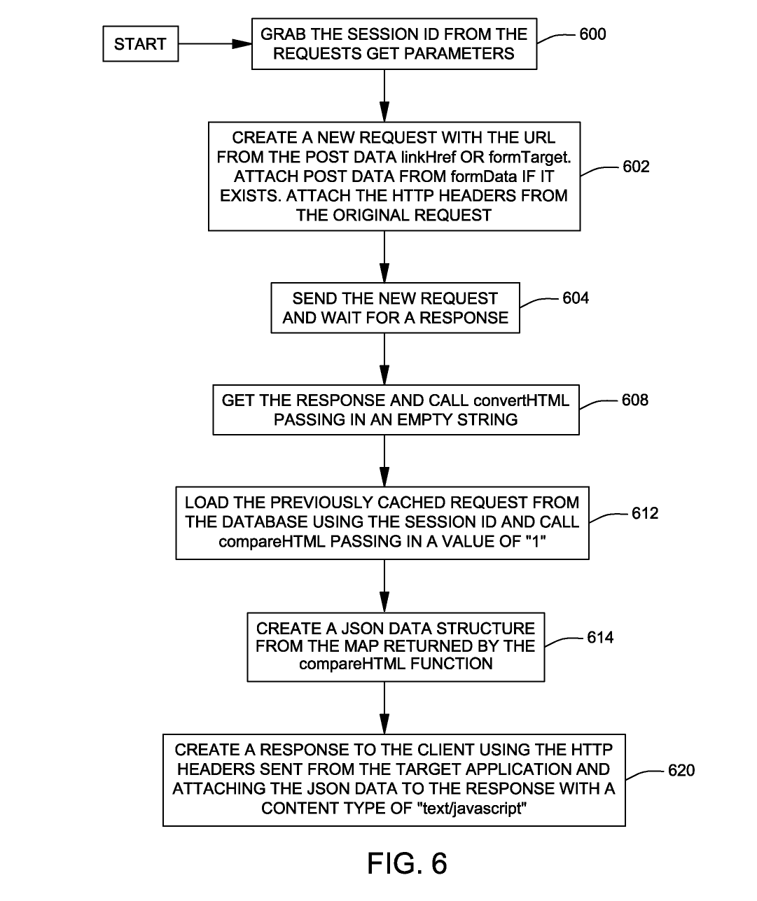

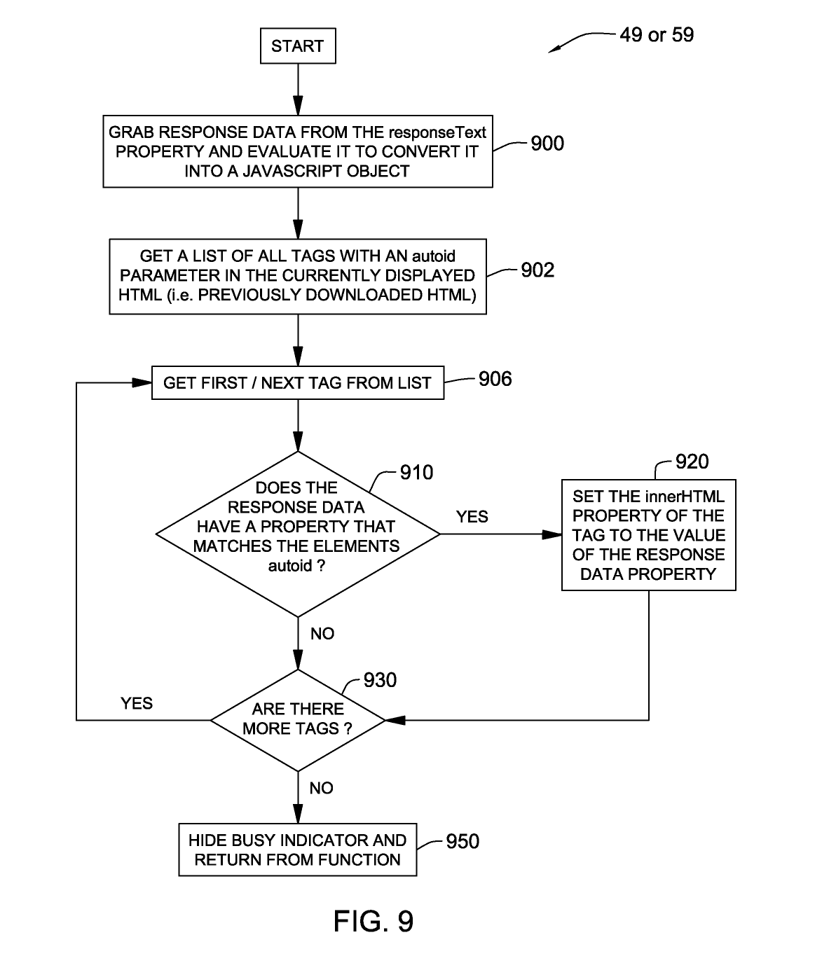

FIG. 6 illustrates in more detail the operation and function of program 29 upon receipt from client computer 40 of a hyperlink request or a form submit request. In step 600, the differencing program 29 reads the session ID from the hyperlink request or form submit request. Next, program 29 creates a request to send the client computer's hyperlink request or form submit request to the web server (such as web server 30) that will actually process the request, i.e. furnish the hyperlinked web page or process the submitted form (step 602). Next, program 29 sends the request it just created to the web server 30 (step 604). Next, the web server 30 processes the request and provides a response, i.e. the hyperlinked web page in the case of a hyperlink request or a suitable response in the case of a form submit request (for example, search results in the case of a form search request or an acknowledgment in the case of a form submit request). After receipt of the response from the web server 30, program 29 calls the conversion routine 39, passing an empty string to indicate that the conversion routing should start from the beginning (step 608). The conversion routine 39 converts the web page in the response (received from web server 30) to the converted HTML form, as described above, i.e. identifies the container tags and their data, and forwards the converted HTML to program 29. In response, program 29 loads the previously cached converted HTML of the previously received web page with the same session ID as that of the current, converted HTML (step 612). In step 612, program 29 also calls a comparison routine 61 to compare the converted HTML of the current response to the converted HTML of the previous response and determines the differences, container by container. The comparison routine 61 returns the differences to program 29. In response, program 29 stores the differences in a data structure file such as a Java Script Object Notation data structure file (step 614). Next, program 29 creates a response to the client computer 40 which will indicate the differences of the current web page (in converted HTML form) to the previous web page furnished to the client (in converted HTML form) (step 620). As explained in more detail below with reference to FIG. 9, the compare routine 61 at server 20 will identify any containers within the new HTML that differ from the corresponding containers in the previously downloaded or constructed HTML, and download the data from the new HTML for the containers that have the changed. The client computer then substitutes the data for the changed containers for the corresponding containers of the previously downloaded or constructed web page/HTML to generate the HTML for the new web page.

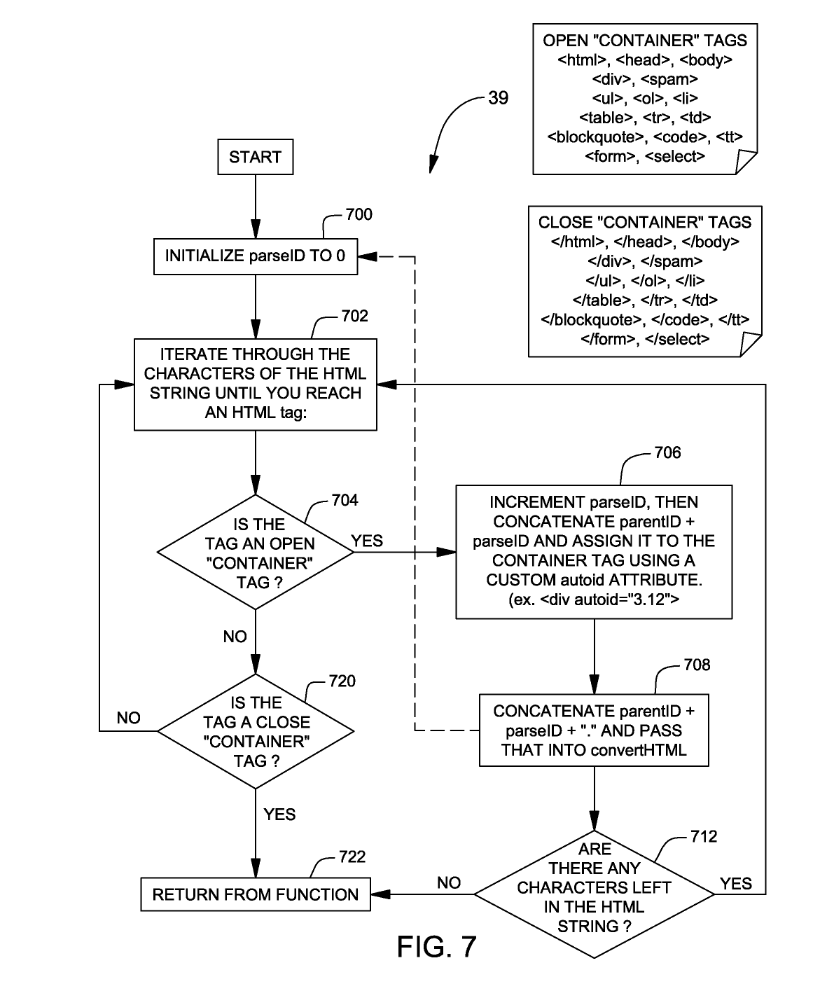

FIG. 7 illustrates the conversion routine 39 in more detail; the conversion routine 39 was called in step 208 of FIG. 2. In step 700, the conversion routine initializes its numbering scheme to zero. Next, the conversion routine identifies the next (in the first iteration the first) tag in the standard HTML of the web page received from web server 30 (step 702). Next, the conversion routine 39 determines if the next tag is an open container tag, i.e. a tag marking the beginning of a type of data for the tag (decision 704). The following are examples of open container tags: <html>, <head>, <body>, <div>, <span>, <ul>, <ol>, <li>, <table>, <tr>, <td>, <blockquote>, <code>, <tt>, <form>, and <select>. If the first tag is an open container tag, the conversion routine 39 determines a unique number to identify the container tag (steps 706 and 708). If the container tag is a parent tag, the conversion routine will assign the next sequential number (for example, in the first iteration, the number “1”) (step 706). However, if the container tag is a child tag (of a parent tag), then the conversion routine will append a suffix to the parent's number (for example, the number “1-1” or “1-2”) (step 708). In step 708, the conversion routine will assign numbers to all children, grandchildren, etc. of the parent. Next, the conversion routine determines if there are any more characters in the original HTML that could possibly be tags that need to be identified (decision 710). If so (decision 710, yes branch), then the conversion routine loops back to step 702 to identify the next tag in the original HTML. If the next tag is a close container, i.e. a tag marking the end of the data for the open tag, then the conversion routine loops back to step 702 to identify the next tag in the original HTML (decision 720, no branch). The following are examples of respective close container tags (for the open container tags noted above): </html>, </head>, </body>, </div>, </span>, /<ul>, </ol>, </li>, </table>, </tr>, </td>, </blockquote>, </code>, </tt>, </form> and </select>. The conversion routine 39 repeats the foregoing conversion process for each container tag in the standard HTML, until there are no more container tags to process (decision 712, no branch and step 722), at which time, the conversion routine 39 returns to program 29 with the converted HTML.

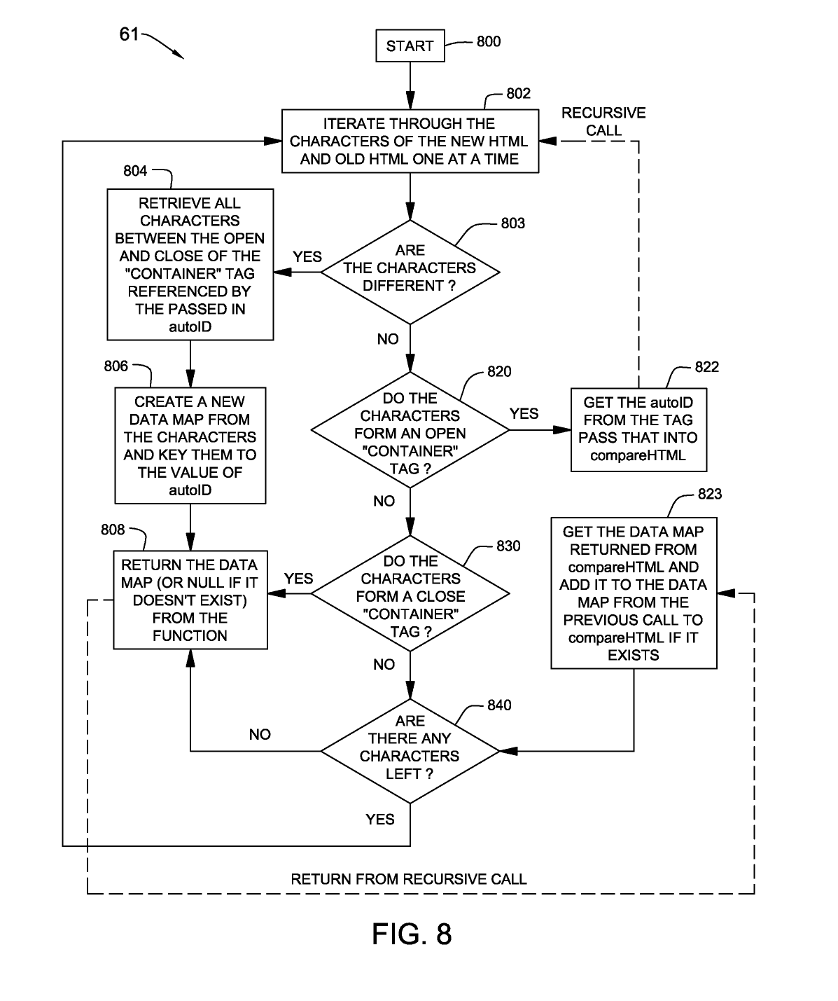

FIG. 8 illustrates in more detail the compare program routine 61 referenced in step 612 of FIG. 6. In step 800, the web page differencing program 29 calls and thereby invokes the compare program routine 61. In response, program routine 61 iterates through the characters, one at a time, of the current HTML and the previously cached HTML for the previous web page (step 812). Next, program 61 compares each character of the new/currently requested HTML to the corresponding character of the previously downloaded HTML (decision 803). If the first character (letter, number or symbol) is not the same in both HTMLs (decision 803, yes branch), then program 61 fetches all characters within the same container, i.e. after the “open” container tag and before the corresponding “close” container tag, in the new HTML (step 804). As explained in more detail below, this container including all its data will be downloaded to the client computer so the client computer can substitute the downloaded container for the container that was previously downloaded and cached at the client computer. Next, program 61 creates a data map to store the information fetched in step 804 and indexes the characters within the container with the ID generated by the web page conversion routine in FIG. 7 for the container (step 806). Next, program 61 returns the data map to the caller (step 808). Thus, when program 61 is performing an intermediary recursive function as described below with reference to step 822, the caller is program 61 so program 61 returns the data map to itself, and then proceeds to step 823 to add the data map for the currently considered container to the data map(s) from the previously considered and processed containers. When program 61 completes the comparison of the new HTML to the previously cached HTML, then program 61 returns to the web page differencing program from step 808 and furnishes to the web page differencing program the data map for the entire HTML.

Referring again to decision 803, no branch, where the character (currently under review) of the new HTML matches the corresponding character in the previously cached HTML, then program routine 61 will determine if the character is an open container tag (decision 820). If not (decision 820, no branch), then program routine 61 will determine if the character is a close container tag (decision 830). If not (decision 830, no branch), then program routine 61 will process the next character if any (decision 840, yes branch). If the character is an open container (decision 820, yes branch), then program routine 61 gets and records the ID from the container tag that was assigned to it from the conversion routine 39 (step 822) and then loops back recursively to step 802 to process the next character. If the character is a close container (decision 830, yes branch), then program routine 61 proceeds to step 808 to return the container tags to the data map without any data in the container. It is not necessary to include any data in the container at this time because so far, the data in this container in the new HTML is the same as the data in the corresponding container in the previously downloaded HTML. However, if a subsequent character in this container in the new HTML differs from the corresponding character in the corresponding container in the previously downloaded HTML, then program routine 61 will include all the data in this container in the data map/difference file for download to the client computer and associate that data with the ID of the container tag. So, the client computer will replace the container of the previously downloaded or constructed HTML with the different container data in the data map/download file.

FIG. 9 illustrates the web page reconstitution programs 49 and 59 in client computers 40 and 50, in more detail. After completion of the comparison program routine 61, web page differencing program 29 sends the data map/difference file to the web browser of the requesting client computer, for example, client computer 40. In response, based on the onload call in the difference file, the web browser 47 forwards the difference file to program 49 as a JSON data structure with a “responseText property”. In step 900, program 49 receives the JSON data structure (i.e. difference file), and converts the difference file into a JavaScript object, using a known JavaScript program function. Next, program 49 gets a list of all the tags and their IDs of the web page that was previously downloaded (step 904). The web page that was previously downloaded is typically currently displayed at the client computer. Next, program 49 reads the first/next tag and its ID of the currently displayed HTML/previously downloaded HTML (step 906), and determines if the difference file contains the same combination of tag and ID (decision 910). If so (decision 910, yes branch), then the difference file contains updated container data for this combination of container tag and ID. Consequently, program 49 substitutes in the HTML of the previously downloaded HTML the new container data for the corresponding container (step 920). When any container in the currently displayed HTML is updated with new data and program 49 sets the inner HTML property of the tag in step 920, the web browser 47 automatically updates the currently displayed web page according to the updated HTML. After step 920 or if there was no match in the difference file for the currently considered combination of container tag and ID of the previously downloaded HTML (decision 910, no branch), then program 49 determines if there are any more container tags in the difference file (decision 930). If so (decision 930, yes branch), then program 49 loops back to step 906 to consider the next container tag in the difference file. The foregoing process is repeated for each container tag in the difference file until they have all been considered (decision 930, no branch), at which time, program 49 hides the busy indicator to notify the user that the web page has been completely updated to form the currently requested web page (step 950).

Programs 29, 39 and 61 can be loaded into server 20 from a computer readable media 65 such as a magnetic tape or disk, optical media, DVD, memory stick, semiconductor memory, etc. or downloaded from the Internet via a TCP/IP adapter card 63.

Program 49 can be loaded into client computer 40 from a computer readable media 149 such as a magnetic tape or disk, optical media, DVD, memory stick, semiconductor memory, etc. or downloaded from the Internet via a TCP/IP adapter card 143.

Program 59 can be loaded into client computer 50 from a computer readable media 159 such as a magnetic tape or disk, optical media, DVD, memory stick, semiconductor memory, etc. or downloaded from the Internet via a TCP/IP adapter card 153.

Based on the foregoing, a computer system, method and program product for minimizing data transfer have been disclosed. However, numerous modifications and substitutions can be made without deviating from the scope of the present invention. Therefore, the present invention has been disclosed by way of illustration and not limitation, and reference should be made to the following claims to determine the scope of the present invention.

What is claimed:

1. A method for reducing data transfer associated with a request for a web page, said method comprising the steps of:
in response to a first request from a client computer for a first web page, a server downloading said first web page to said client computer, and said client computer storing said first web page;
in response to a second, subsequent request from said client computer for a second web page, said server downloading to said client computer differences between said second web page and said first web page; and
said client computer constructing said second web page based on said first web page and said differences between said second web page and said first web page.

2. A method as set forth in claim 1 wherein said differences comprise a container of an HTML of said second web page where at least one character in said container of said second web page differs from at least one corresponding character in a corresponding container of said first web page.

3. A method as set forth in claim 2 wherein said client computer constructs said second web page by substituting said container of the HTML for said second web page for the corresponding container of the HTML of said first web page.

4. A method as set forth in claim 1 further comprising the steps of:
said server storing said first web page and comparing an HTML for said second web page to an HTML for said first web page, container by container, to identify which containers of the HTML for said second web page differ from corresponding containers of the HTML for said first web page to determine differences between said second web page and said first web page.

5. A system for reducing data transfer associated with a request for a web page, said system comprising:
means within a server, responsive to a first request from a client computer for a first web page, for downloading said first web page to said client computer, and means within said client computer for storing said first web page;
means within said server, responsive to a second, subsequent request from said client computer for a second web page, for downloading to said client computer differences between said second web page and said first web page; and
means within said client computer for constructing said second web page based on said first web page and said differences between said second web page and said first web page.

6. A system as set forth in claim 5 wherein said differences comprise a container of an HTML of said second web page where at least one character in said container of said second web page differs from at least one corresponding character in a corresponding container of said first web page.

7. A system as set forth in claim 6 wherein the constructing means within said client computer constructs said second web page by substituting said container of the HTML for said second web page for the corresponding container of the HTML of said first web page.

8. A system as set forth in claim 5 further comprising:
means within said server for storing said first web page and comparing an HTML for said second web page to an HTML for said first web page, container by container, to identify which containers of the HTML for said second web page differ from corresponding containers of the HTML for said first web page to determine differences between said second web page and said first web page.

9. A computer program product for reducing data transfer associated with a request for a web page, said computer program product comprising:
a computer readable media;
first program instructions for execution within a server, responsive to a first request from a client computer for a first web page, to download said first web page to said client computer, and second program instructions for execution within said client computer to store said first web page;
third program instructions for execution within said server, responsive to a second, subsequent request from said client computer for a second web page, to download to said client computer differences between said second web page and said first web page; and
fourth program instructions for execution within said client computer to construct said second web page based on said first web page and said differences between said second web page and said first web page; and wherein
said first, second, third and fourth program instructions are stored on said media in functional form.

10. A computer program product as set forth in claim 9 wherein said differences comprise a container of an HTML of said second web page where at least one character in said container of said second web page differs from at least one corresponding character in a corresponding container of said first web page.

11. A computer program product as set forth in claim 6 wherein said fourth program instructions construct said second web page by substituting said container of the HTML for said second web page for the corresponding container of the HTML of said first web page.

12. A computer program product as set forth in claim 9 further comprising:
fifth program instructions for execution within said server to store said first web page and compare an HTML for said second web page to an HTML for said first web page, container by container, to identify which containers of the HTML for said second web page differ from corresponding containers of the HTML for said first web page to determine differences between said second web page and said first web page; and wherein
said fifth program instructions are stored on said media in functional form.
